(19) United States
(12) Patent Application Publication
(10) Pub. No.: US 2020/0330939 A1
(43) Pub. Date: Oct. 22, 2020

(54) VIBROMIXER FOR MIXING LIQUIDS, LIQUIDS WITH GASES OR SOLIDS IN FLEXIBLE DISPOSABLE CONTAINERS

(71) Applicant: DRM, DR. MÜLLER AG, Männedorf (CH)

(72) Inventors: Kevin Martin WETTER, Winterthur (CH); Patrick MÜLLER, Männedorf (CH)

(73) Assignee: DRM, Dr. Müller AG, Männedorf (CH)

(21) Appl. No.: 16/305,268

(22) PCT Filed: Jun. 7, 2017
(86) PCT No.: PCT/CH2017/000055

§ 371 Date: Nov. 28, 2018

(30) Foreign Application Priority Data
Jun. 17, 2016 (CH) 00776/16

(51) Int. Cl. B01F 11/00; B01F 15/00

(52) U.S. Cl. CPC B01F 11/0082; B01F 11/0097; B01F 15/0085

(57) ABSTRACT

A vibromixer for mixing liquids, or liquids with gases or solids, consists of a container made of flexible plastic and a drive shaft comprising a mixer plate situated on the lower end of the drive shaft, wherein the container is supported in a support container.

The invention relates to a vibromixer for mixing liquids, liquids with gases, or solids, consisting of a container made of flexible plastic and a drive shaft comprising a mixer plate situated on the lower end of the drive shaft, wherein the container is supported in a support container.

Such a vibromixer is described in CH 289065 for mixing liquids. The drive is generally pneumatic or electromagnetic, wherein a vertical vibration of 50 Hz to 60 Hz is transferred to a stirrer. Generally, the electromagnet is operated with line current which generates an alternating field in the vertical direction and, therefore, vertically attracts a magnetizable steel plate. During this motion, the springs mounted on the steel plate are compressed. When the magnetic field changes, the energy stored in the spring presses the steel plate back into the original position. Since the steel plate is attracted in the case of a magnetic N field as well as an S field, the oscillation doubles as compared to that of the alternating current, i.e., an alternating current of 50 Hz generates, on the electromagnet, an oscillation of the mixing element of 100 Hz.

Due to several cones situated on the mixer plate at a given angle, a uniform mixing field with axial circulation is induced, which provides for rapid homogenization in short mixing times. The known vibromixers have the disadvantage that all contact faces with the medium to be mixed consist of steel or the like and the mixers are mostly operated in stainless steel containers. This requires or renders impossible an efficient cleaning and sterilization of the equipment after a change of product. So-called disposable containers made of flexible plastic are in demand in the biopharmaceutical industry in particular, since such containers require no complex cleaning. Instead, such containers are disposed of or recycled after use and, therefore, allow for a flexible and rapid change of product with low investment costs.

DE 102006022914 describes a disposable mixing reactor comprising a rotating mixing device. The distinctive disadvantages thereof are the complex requirements on the rotational seal as well as the large dimensions of the stirring element, which results in disadvantages primarily with respect to costs for manufacturing as well as storage and transport. In addition, the mixing field induced by a rotating element, which has high shear forces and an inhomogeneous mixing distribution, has disadvantages in biopharmaceutical applications, in particular.

Another approach is described by DE 102006018824. In this case, the mixing is generated by the rocking and pivoting of the entire disposable container without an additional stirring element in the container interior. The achievable homogeneity and mixing quality with larger volumes, in particular, is insufficient for most applications, however.

EP 0653960 provides that the mixing is generated with the aid of a magnetic stirrer near the bottom, within the disposable container. In this case as well, a sufficient mixing quality can be achieved only locally and, therefore, is not usable for larger container volumes. One further disadvantage of the magnetic stirrer is the service life of the bearings. In addition, non-plastic materials are present in the disposable system, which must be removed—which requires a great deal of effort—before disposal or recycling.

The utility model DE 202008016498U describes a container comprising a flexible container wall and a hollow mixer shaft in the container interior, which is guided through the container wall and is connected to the mixer in a communicating manner. In this case, the hollow mixer shaft is designed to be stabilizable by a free-flowing medium which can be brought in from the outside. This allows for the improvement of known containers in the sense that the part of the mixer shaft extending into the container interior is foldable and the container can be folded up to a small packaging size. The efficiency of the transmission of the mixing energy from the mixer to the mixer plate and, finally, into the medium to be mixed is highly dependent on the stability of the mixer shaft. A free-flowing medium must be introduced in order to stabilize the mixer shaft. In order to sufficiently form the stabilization chamber during the introduction of gases, high pressures are necessary, which require a high tensile strength of the material utilized for the stabilization chamber and/or a safety valve. When free-flowing and curable media are utilized for forming the stabilization chamber, the inflating medium can be removed only to a limited extent after the container has been utilized, cannot be reused, and must be disposed of together with the disposable container.

DE 202007005400U U1 describes a container comprising a flexible container wall, which is utilized in a support container for mixing a liquid medium, wherein the lateral support surface includes at least one baffle which forms the lateral container wall and supports the mixing process.

A mixer shaft made of solid plastic is connected to a mixing drive outside the container. A mixing element made of plastic, which can also be vibration mixer element, is situated at the end of the mixer shaft. There is no discussion, however, of the manner in which the mixer shaft is connected to the mixing element, nor whether this connection is permanent or can be locked and/or released from outside the container.

U.S. Pat. No. 8,342,737 B2 also describes a flexible disposable container, in the case of which a hollow, stable drive shaft is guided through the upper container wall and is sealingly connected to the flexible container wall. The drive shaft is connected outside the container to a vibration drive and within the container to at least one mixer plate including conical bores. The mixer shaft is not detachably connected to the flexible container and, therefore, after use, a great deal of effort is required in order to make the mixer shaft usable again and to utilize it once again. The use of an open hollow tube in the container also makes it difficult to aseptically seal the container.

The problem addressed by the invention is that of creating a device which eliminates the described disadvantages and provides a simplified vibromixer with a single use of the stirring or mixing container having a high mixing efficiency and mixing quality. This has the advantage of being very useful, above all, in the preparation of medicines in the pharmaceutical industry, in biological applications such as fermentation processes, in the cultivation of microorganisms in bioreactors, but also in fields of application where mixing efficiency and quality with a high process flexibility are generally required.

The problem is solved according to the invention in that the container is provided with a flexible inner tube—in the interior of the container, sealingly with the wall of the container in the upper area—which is integrally connected to the mixer plate and encloses the drive shaft. This arrangement makes it possible to insert the solid drive shaft to the mixer plate, to detachably connect the drive shaft, and to reuse the drive shaft for a further disposable container. Since the drive shaft has no contact to the medium to be mixed, the drive shaft can be manufactured of solid plastic or steel as necessary, wherein the latter allows for a considerably greater mixing input due to the better mechanical stability. Due to the omission of extended, solid components made of plastic, the sterile disposable container can be compactly folded and stored, and is cost-effective to manufacture. The disposable container consists of a flexible plastic, which is compatible for biopharmaceutical processes, on all contact faces which are in contact with medium and, therefore, can be utilized for numerous applications. It is particularly advantageous that the container is supported in a support container. The support container also provides a greater volume of the disposable container with the required stability. It is advantageous that the container is connected to a flexible inner tube and is sealingly connected to the wall of the container in the upper area and is integrally connected to the mixer plate in the lower area. This has the advantage that the entire inner area of the mixer is hermetically sealed, no leaks occur, and the media to be mixed cannot be contaminated. It is also advantageous that all inner contact faces, in particular, the mixer plate, consist of process-compatible, chemically resistant plastics, and so contamination can be reduced. It is advantageous that the drive shaft is detachably connected in its upper portion to a vibration drive and also in the lower area to a mixer plate made of plastic. This permits the shaft to be removed after use and, therefore, provides for a rapid change-over and reduced disposal volumes and costs of the disposable containers. The fastening of the container on the support container is also simple to lock and release. This also promotes a rapid and user-friendly removal and replacement of the disposable mixing system. All connections between the plastics are sealingly welded or bonded. This reduces the risk of a leak and/or contamination. During operation, the inner tube is provided with a removable support tube made of plastic or steel, which protects the inner tube from the oscillating drive shaft. This has the advantage that the flexible plastic cannot be overstressed.

In one further embodiment, the vibration drive and the drive shaft can be installed from the bottom, wherein the mixer plate can also be clamped in position from the bottom. This has the advantage that the shaft length is shortened, the lateral flows can therefore be better captured by the shaft, and the required drive power of the vibromixer is reduced due to the reduced load. The invention is explained in greater detail with reference to a drawing.

Wherein:

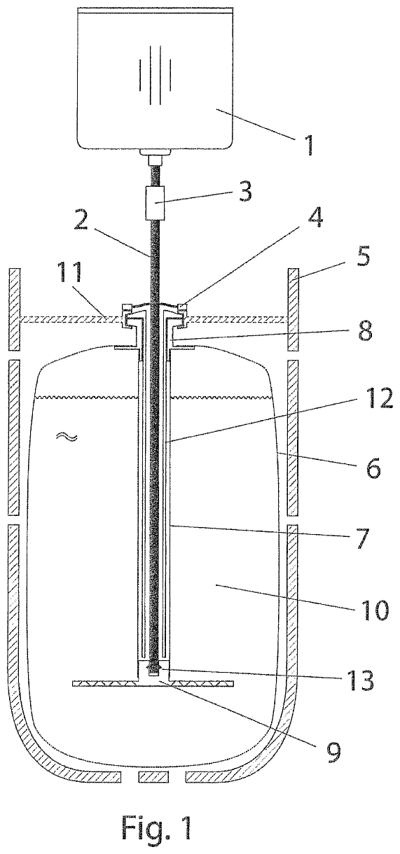

FIG. 1 shows a longitudinal section of the vibromixer according to the invention comprising a disposable container, and

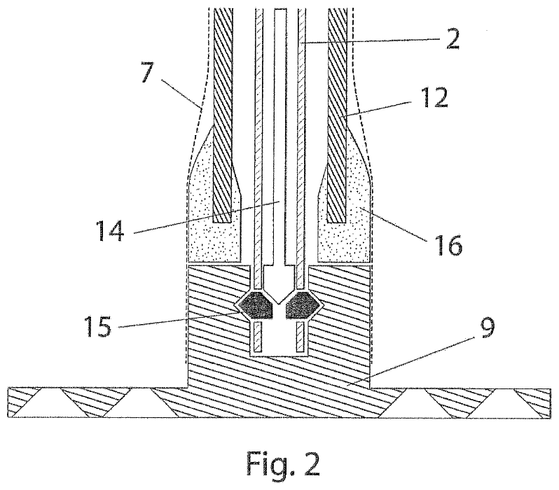

FIG. 2 shows a longitudinal section of a detailed representation of the detachable connection to the mixer plate.

In FIG. 1, a vibration drive is represented with the reference sign 1. A drive shaft 2 is connected, in a known way, to the vibration drive 1 with the aid of a clamping connection 3 and is fastened on the support container 5 with the aid of a centering element 4. This fastening 4—consisting, for example, of a steel spring, tensioning lines, or a diaphragm made of elastomers—permits the guidance of the shaft 2 along the longitudinal axis of the support container 4, wherein the oscillating, vertical motion is not impeded. The container (disposable container) 6, the wall of which consists of flexible plastic, is connected to an inner tube 7 made of flexible plastic and is sealingly connected at the container wall via a flange 8 made of rigid plastic and at a mixer plate 9 made of rigid plastic. The container 6, filled via the inner tube 7 with the medium 10 to be mixed, is supported by the support container 5 and is held in form and is detachably fixed on the support container 5 at the flange 8 in the upper area with the aid of a clamping device 11. A hollow support tube 12 made of plastic or metal is inserted through the inner tube 7 and is also fixed on the clamping device 11. The drive shaft 2 can now also be inserted into the support tube 12 and connected to the mixer plate 9 via a detachable connection 13.

In FIG. 2, the connection between the mixer plate 9 and the drive shaft 2 is shown. The connecting mechanism according to the invention, consisting of a hollow drive shaft 2, an impact or pulling element 14 (referred to in the following as a plunger) as well as several clamping bodies 15, is inserted from above through the inner tube 7 into the mixer plate 9. This is to be carried out without friction, since greater loads on the flexible plastics are to be avoided during installation. In order to fix the drive shaft 2 on the mixer plate 9, the clamping bodies 15 are spread and pressed into the inner groove of the mixer plate 9. For this purpose, a mechanism is utilized, which makes it possible to spread and fasten the clamping bodies 15 through the hollow drive shaft 2 from outside the inner tube 7, preferably from above the container 6. The spreading of the clamping bodies 15 is carried out with the aid of a plunger 14, wherein two variants for the locking and fastening thereof are provided. (A) The plunger 14 is provided with an extension which, guided through the hollow drive shaft 2, can be fixed on the upper end outside the inner tube 7, for example, with the aid of a thread or a screw connection. (B) The plunger 14 is provided with a thread or a screw connection in the lower area within the hollow drive shaft 2 and is locked with the aid of a removable tool (not represented) from above the inner tube 7 through the hollow drive shaft 2. For both variants (A and B), the plunger 14 can also be released again in the same way, wherein a trouble-free release of the connection is made possible by way of the selected angle of the clamping bodies 15 and the inner geometry of the mixer plate 9 after the plunger 14 has been loosened. The selected length measurements for the inner tube 7, the drive shaft 2, and the support tube 12 are selected in such a way that there is no direct contact between the support tube 12 and the mixer plate 9. During normal operation, the mixer plate 9 oscillates, driven by the vibration drive 1 and the connected drive shaft 2, with an amplitude of 2 mm to 5 mm; the support tube 12 is fixed on the support container 5, however, and undergoes no active motion. The oscillating motion is therefore absorbed by the inner tube 7 in the proximity of the mixer plate 9, wherein this can be optionally supported by a damper material 16 made of elastomers or foamed plastics. The function of the support tube 12 consists in absorbing the pressure of the medium 10 to be mixed on the inner tube 7 and preventing the contact of the flexible tube to the drive shaft 2 and the contact of the mixer plate 9 to the support tube 12.

1. A vibromixer comprising an oscillating drive shaft (2), for mixing liquids, liquids with gases or solids, including a container (6) made of flexible plastic and a drive shaft (2) comprising a mixer plate (9) situated on the lower end of the drive shaft (2), wherein the container (6) is supported in a support container (5), wherein the container (6) is provided with a flexible inner tube (7)—in the interior of the container (6), sealingly with the wall of the container (6) in the upper area—which is integrally connected to the mixer plate (9) and encloses the drive shaft (2), wherein the vibromixer comprises a removable support tube (12) made of plastic or steel, and the inner tube (7) is protected from the oscillating drive shaft (2) during the operation by the support tube (12).

2. The device as claimed in claim 1, wherein the drive shaft (2) is connected in its upper portion via a detachable clamping connection (3) to a vibration drive (1).

3. The device as claimed in claim 1, wherein the connection between the container (6) and the inner tube (7) via the flange (8) made of plastic is welded, bonded, or clamped.

4. The device as claimed in claim 1, wherein the connection between the inner tube (7) and the mixer plate (9) made of plastic is welded, bonded, or clamped.

5. (canceled)

6. The device as claimed in claim 1, wherein the drive shaft (2) carries a mixer plate (9) made of plastic and is detachably connected thereto.

7. The device as claimed in claim 1, wherein the shaft (2) can be connected to and released from the mixer plate (9) from outside the inner tube (7) and the container (6) with the aid of a tool or a mechanism (13).

8. The device as claimed in claim 1, wherein the upper end of the inner tube (7) and the container (6) is detachably connected to the clamping device (11) via the flange (8).

9. The device as claimed in claim 1, wherein the vibration drive (1) and the drive shaft (2) can be installed from the bottom, wherein the mixer plate (6) including the inner tube (7) and the connecting shaft (2) can also be clamped from the bottom, in a mirror-image arrangement.
